(19) United States
(12) Patent Application Publication
(10) Pub. No.: US 2008/0076315 A1
(43) Pub. Date: Mar. 27, 2008

(54) Elastic Composite Having Barrier Properties

(76) Inventors: Ann L. McCormack, Cumming, GA (US); Jose Siqueira, Roswell, GA (US); Laura Elizabeth Keck, Alpharetta, GA (US)

Correspondence Address: DORITY & MANNING, P.A., POST OFFICE BOX 1449, GREENVILLE, SC, 29602-1449, US

(21) Appl. No.: 11/774,016

(22) Filed: Jul. 6, 2007

Related U.S. Application Data
(60) Provisional application No. 60/847,560, filed on Sep. 27, 2006.

(51) Int. Cl. D04H 13/02; B29C 65/02

(52) U.S. Cl. 442/328; 156/322

(57) ABSTRACT

An elastic composite that contains an elastic film laminated to one or more nonwoven materials is provided. By selectively controlling the constituents of the composite and the method by which it is formed, the present inventors have discovered that the composite may be resistant to oils and other skin care compositions. More specifically, the elastic film is formed from one or more low density semi-crystalline propylene-based polymers that possess a unique combination of mechanical, elastic, and oil-resistant properties. By using such elastomeric polymers, the resulting elastic film may also be thermally bonded to the nonwoven web material(s) without the need for oil-resistant adhesives. Further, the bonding conditions may be selected so that apertures do not form in the film. In this manner, the resulting composite is impervious to oils or other liquids (e.g., solvents, water, solutions, etc.) and thus acts as a barrier during use.

### RELATED APPLICATIONS

The present application claims priority to U.S. Provisional Application No. 60/847,560, filed on Sep. 27, 2006.

### BACKGROUND OF THE INVENTION

Elastic composites are commonly incorporated into products (e.g., skin care products, personal care products, garments, etc.) to improve their ability to better fit the contours of the body. For example, the elastic composite may be formed from an elastic film joined to one or more nonwoven web materials. In many cases, the products into which such elastic composites are incorporated also contain a skin care composition, such as oils (e.g., mineral oil, petrolatum, and so forth), waxes, creams, lotions, gels, etc. The skin care composition may be applied directly to the elastic material, or may eventually contact the elastic material during use. In either case, skin care compositions may cause a variety of problems for elastic materials made of certain types of elastomeric polymers. Styrene-olefin block copolymers (e.g., styrene-ethylene-butylene-styrene tetrablock copolymers), for instance, are oleophilic by nature and tend to swell, soften, and even dissolve in the presence of oleophilic skin care compositions (e.g. oils). Not only does this adversely affect the stretch and recovery properties of the elastic material, but it may also cause the composite to delaminate and thereby destroy the integrity of the product.

Various attempts have been made to overcome these problems. For instance, U.S. Patent Application Publication No. 2004/0121692 to Taylor, et al., which is incorporated herein in its entirety by reference thereto for all purposes, describes an elastic composite that contains an elastomeric sheet treated with an oil-insensitive adhesive on at least one surface of the elastomeric sheet, and at least one nonwoven facing sheet laminated to the at least one surface of the elastomeric sheet. The oil-insensitive adhesive bonds or augments the bonding between elastomeric sheets and facing sheets so that the resulting laminates have greatly improved resistance to degradation when exposed to oil-based products. Despite the improvements made, however, oil-insensitive adhesives are often costly and may lead to an overly complex lamination process.

As such, a need remains for a simple and inexpensive elastic composite that still remains resistant to oils.

### SUMMARY OF THE INVENTION

In accordance with one embodiment of the present invention, a nonwoven composite is disclosed that comprises an elastic film positioned adjacent and thermally fused to a nonwoven web material at a plurality of discrete bond sites. The elastic film comprises a semi-crystalline propylene-based polymer having a density of about 0.88 grams per cubic centimeter or less, wherein the composite is substantially liquid-impervious.

In accordance with another embodiment of the present invention, a method of forming a nonwoven composite is disclosed. The method comprises forming an elastic film from a polymer composition, the polymer composition comprising a semi-crystalline propylene-based polymer having a density of about 0.88 grams per cubic centimeter or less. The film and a nonwoven web material are passed through a nip formed by at least one patterned roll. At the nip, the film is thermally fused to the nonwoven web material, the thermally fused film being generally free of apertures having a size of about 10 micrometers or greater.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 illustrates a process for manufacturing an elastic composite according to an exemplary embodiment of the present invention;

FIG. 2 is a perspective view of one embodiment of a glove formed according to the present invention.

Repeat use of reference characters in the present specification and drawings is intended to represent same or analogous features or elements of the invention.

### DETAILED DESCRIPTION OF REPRESENTATIVE EMBODIMENTS

### Definitions

As used herein the term “nonwoven web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth.

As used herein, the term “meltblown web” generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 microns in diameter, and generally tacky when deposited onto a collecting surface.

As used herein, the term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. Nos. 4,340,563 to Appel, et al., 3,692,618 to Dorschner, et al., 3,802,817 to Matsuki, et al., 3,338,992 to Kinney, 3,341,394 to Kinney, 3,502,763 to Hartman, 3,502,538 to Levy, 3,542,615 to Dobo, et al., and 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 microns, and are often between about 5 to about 20 microns.

As used herein, the terms “machine direction” or “MD” generally refers to the direction in which a material is produced. The term “cross-machine direction” or “CD” refers to the direction perpendicular to the machine direction.

As used herein the terms “extensible” or “extensibility” generally refers to a material that stretches or extends in the direction of an applied force by at least about 25%, in some embodiments at least about 50%, and in some embodiments, at least about 75% of its relaxed length or width. An extensible material does not necessarily have recovery properties. For example, an elastomeric material is an extensible material having recovery properties. A meltblown web may be extensible, but not have recovery properties, and thus, be an extensible, non-elastic material.

As used herein, the term “set” refers to retained elongation in a material sample following the elongation and recovery, i.e., after the material has been stretched and allowed to relax during a cycle test.

As used herein, the term “percent set” is the measure of the amount of the material stretched from its original length after being cycled (the immediate deformation following the cycle test). The percent set is where the retraction curve of a cycle crosses the elongation axis. The remaining strain after the removal of the applied stress is measured as the percent set. The percent set for the elastic composite of the present invention after 1 cycle may, for example, be about 18% or less, in some embodiments about 15% or less, and in some embodiments, about 13% or less.

As used herein, the term “elastomeric” and “elastic” and refers to a material that, upon application of a stretching force, is stretchable in at least one direction (such as the CD direction), and which upon release of the stretching force, contracts/returns to approximately its original dimension. For example, a stretched material may have a stretched length that is at least about 50%, in some embodiments at least about 60%, and in some embodiments, at least about 75% greater than its relaxed unstretched length. Likewise, the stretched material will recover to within at least about 50%, in some embodiments at least about 60%, and in some embodiments, at least about 75% of its stretched length upon release of the stretching force. A hypothetical example would be a one (1) inch sample of a material that is stretchable to at least 1.50 inches and which, upon release of the stretching force, will recover to a length of not more than 1.25 inches.

As used herein, the terms “necked” and “necked material” generally refer to any material that has been drawn in at least one dimension (e.g., machine direction) to reduce its transverse dimension (e.g., cross-machine direction) so that when the drawing force is removed, the material may be pulled back to its original width. The necked material generally has a higher basis weight per unit area than the un-necked material. When the necked material is pulled back to its original width, it should have about the same basis weight as the un-necked material. This differs from the orientation of a film in which the film is thinned and the basis weight is reduced. The necking method typically involves unwinding a material from a supply roll and passing it through a brake nip roll assembly driven at a given linear speed. A take-up roll or nip, operating at a linear speed higher than the brake nip roll, draws the material and generates the tension needed to elongate and neck the material.

As used herein, the term “thermal point bonding” generally refers to a process performed, for example, by passing a material between a patterned roll (e.g., calender roll) and another roll (e.g., anvil roll), which may or may not be patterned. One or both of the rolls are typically heated.

As used herein, the term “ultrasonic bonding” generally refers to a process performed, for example, by passing a material between a sonic horn and a patterned roll (e.g., anvil roll). For instance, ultrasonic bonding through the use of a stationary horn and a rotating patterned anvil roll is described in U.S. Pat. Nos. 3,939,033 to Grgach, et al., 3,844,869 to Rust Jr., and 4,259,399 to Hill, which are incorporated herein in their entirety by reference thereto for all purposes. Moreover, ultrasonic bonding through the use of a rotary horn with a rotating patterned anvil roll is described in U.S. Pat. Nos. 5,096,532 to Neuwirth, et al., 5,110,403 to Ehlert, and 5,817,199 to Brennecke, et al., which are incorporated herein in their entirety by reference thereto for all purposes. Of course, any other ultrasonic bonding technique may also be used in the present invention.

### DETAILED DESCRIPTION

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally speaking, the present invention is directed to an elastic composite that contains an elastic film laminated to one or more nonwoven materials. By selectively controlling the constituents of the composite and the method by which it is formed, the present inventors have discovered that the composite may be resistant to oils and other skin care compositions. More specifically, the elastic film is formed from one or more low density semi-crystalline propylene-based polymers that possess a unique combination of mechanical, elastic, and oil-resistant properties. Using such elastomeric polymers, the resulting elastic film may also be thermally bonded to the nonwoven web material(s) without the need for oil-resistant adhesives. Further, the bonding conditions may be selected so that apertures do not generally form in the film. In this manner, the resulting composite is impervious to liquids (e.g., oils) and thus acts as a barrier during use. Various embodiments of the present invention will now be described in more detail.

### I. Elastic Film

Semi-crystalline propylene-based polymers have or are capable of exhibiting a substantially regular structure. For example, semi-crystalline propylene-based polymers may be substantially amorphous in their undeformed state, but form crystalline domains upon stretching. The degree of crystallinity may be from about 3% to about 30%, in some embodiments from about 5% to about 25%, and in some embodiments, from about 5% and about 15%. Likewise, the semi-crystalline propylene-based polymer may have a latent heat of fusion (ΔH_{f}), which is another indicator of the degree of crystallinity, of from about 15 to about 75 Joules per gram (“J/g”), in some embodiments from about 20 to about 65 J/g, and in some embodiments, from 25 to about 50 J/g. The semi-crystalline propylene-based polymer may also have a Vicat softening temperature of from about 10° C. to about 100° C., in some embodiments from about 20° C. to about 80° C., and in some embodiments, from about 30° C. to about 60° C. The semi-crystalline propylene-based polymer may have a melting temperature of from about 20° C. to about 120° C., in some embodiments from about 35° C. to about 90° C., and in some embodiments, from about 40° C. to about 80° C. The latent heat of fusion (ΔH_{f}) and melting temperature may be determined using differential scanning calorimetry (“DSC”) in accordance with ASTM D-3417 as is well known to those skilled in the art. The Vicat softening temperature may be determined in accordance with ASTM D-1525.

In one particular embodiment, the semi-crystalline propylene-based polymer includes a copolymer of propylene and an α-olefin, such as a C₂-C₂₀ α-olefin or C₂-C₁₂ α-olefin. Suitable α-olefins may be linear or branched (e.g., one or more C₁-C₃ alkyl branches, or an aryl group). Specific examples include ethylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are ethylene, 1-butene, 1-hexene and 1-octene. The propylene content of such copolymers may be from about 60 mole % to about 99.5 wt. %, in some embodiments from about 80 mole % to about 99 mole %, and in some embodiments, from about 85 mole % to about 98 mole %. The α-olefin content may likewise range from about 0.5 mole % to about 40 mole %, in some embodiments from about 1 mole % to about 20 mole %, and in some embodiments, from about 2 mole % to about 15 mole %. The distribution of the α-olefin comonomer is typically random and uniform among the differing molecular weight fractions forming the propylene copolymer.

Any of a variety of known techniques may generally be employed to form the semi-crystalline polyolefins. For instance, olefin polymers may be formed using a free radical or a coordination catalyst (e.g., Ziegler-Natta). Preferably, the olefin polymer is formed from a single-site coordination catalyst, such as a metallocene catalyst. Such a catalyst system produces ethylene copolymers in which the comonomer is randomly distributed within a molecular chain and uniformly distributed across the different molecular weight fractions. Metallocene-catalyzed polyolefins are described, for instance, in U.S. Pat. Nos. 5,571,619 to McAlpin et al.; 5,322,728 to Davis et al.; 5,472,775 to Obijeski et al.; 5,272,236 to Lai et al.; and 6,090,325 to Wheat, et al., which are incorporated herein in their entirety by reference thereto for all purposes. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (M_{w}/Mₙ) of below 4, controlled short chain branching distribution, and controlled isotacticity.

The density of the propylene/α-olefin copolymer may be a function of both the length and amount of the α-olefin. That is, the greater the length of the α-olefin and the greater the amount of α-olefin present, the lower the density of the copolymer. Although the density of the propylene-based polymer employed in the present invention may vary, it is typically about 0.88 grams per cubic centimeter (g/cm³) or less, in some embodiments, from about 0.83 to about 0.88 g/cm³, and in some embodiments, from about 0.85 g/cm³ to about 0.87 g/cm³. The melt flow rate of the propylene-based polymer may also be selected within a certain range to optimize the properties of the resulting elastic film. The melt flow rate is the weight of a polymer (in grams) that may be forced through an extrusion rheometer orifice (0.0825-inch diameter) when subjected to a force of 2160 grams in 10 minutes at 230° C. Generally speaking, the melt flow rate is high enough to improve melt processability, but not so high as to adversely interfere with the binding properties of the film. Thus, in most embodiments of the present invention, the propylene-based polymer has a melt flow index of from about 0.1 to about 10 grams per 10 minutes, in some embodiments from about 0.2 to about 5 grams per 10 minutes, and in some embodiments, from about 0.5 to about 4 grams per 10 minutes, measured in accordance with ASTM Test Method D1238-E.

Suitable propylene polymers are commercially available under the designations VISTAMAXX™ from ExxonMobil Chemical Co. of Houston, Tex.; FINA™ (e.g., 8573) from Atofina Chemicals of Feluy, Belgium; TAFMER™ available from Mitsui Petrochemical Industries; and VERSIFY™ available from Dow Chemical Co. of Midland, Mich. Other examples of suitable propylene polymers are described in U.S. Pat. Nos. 7,105,609 to Datta, et al.; 6,500,563 to Datta, et al.; 5,539,056 to Yang, et al.; and 5,596,052 to Resconi, et al., which are incorporated herein in their entirety by reference thereto for all purposes.

Of course, other thermoplastic polymers may also be used to form the elastic film so long as they do not adversely affect the elastic and barrier properties of the composite. For example, the elastic film may contain other polyolefins, elastomeric polyesters, polyurethanes, polyamides, block copolymers, and so forth. For example, polyethylene may be employed in some embodiments of the present invention. The density of the polyethylene may vary depending on the type of polymer employed, but generally ranges from 0.85 to 0.96 grams per cubic centimeter (“g/cm³”). Polyethylene “plastomers”, for instance, may have a density in the range of from 0.85 to 0.91 g/cm³. Likewise, “linear low density polyethylene” (“LLDPE”) may have a density in the range of from 0.91 to 0.940 g/cm³; “low density polyethylene” (“LDPE”) may have a density in the range of from 0.910 to 0.940 g/cm³; and “high density polyethylene” (“HDPE”) may have density in the range of from 0.940 to 0.960 g/cm³.

Regardless of the polymers employed, the amount of semi-crystalline propylene-based polymer(s) is typically about 30 wt. % or more of the film, in some embodiments about 50 wt. % or more, and in some embodiments, about 80 wt. % or more of the of the film. When a blend of polymers is employed, the semi-crystalline polyolefin(s) may constitute from about 50 wt. % to about 99 wt. %, in some embodiments from about 60 wt. % to about 98 wt. %, and in some embodiments, from about 65 wt. % to about 96 wt. % of the blend. It should of course be understood that other elastomeric and/or non-elastomeric polymers may also be employed in the film.

Besides polymers, the elastic film of the present invention may also contain other additives as is known in the art, such as melt stabilizers, processing stabilizers, heat stabilizers, light stabilizers, antioxidants, heat aging stabilizers, whitening agents, antiblocking agents, bonding agents, tackifiers, viscosity modifiers, etc. Suitable viscosity modifiers may include, for instance, polyethylene wax (e.g., EPOLENE™ C-10 from Eastman Chemical). Phosphite stabilizers (e.g., IRGAFOS available from Ciba Specialty Chemicals of Terrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of films. Some suitable hindered phenols include those available from Ciba Specialty Chemicals of under the trade name “Irganox®”, such as Irganox® 1076, 1010, or E 201. Moreover, bonding agents may also be added to the film to facilitate bonding of the film to additional materials (e.g., nonwoven web). When employed, such additives (e.g., tackifier, antioxidant, stabilizer, etc.) may each be present in an amount from about 0.001 wt. % to about 25 wt. %, in some embodiments, from about 0.005 wt. % to about 20 wt. %, and in some embodiments, from 0.01 wt. % to about 15 wt. % of the film.

The elastic film of the present invention may be mono- or multi-layered. Multilayer films may be prepared by co-extrusion of the layers, extrusion coating, or by any conventional layering process. Such multilayer films normally contain at least one base layer and at least one skin layer, but may contain any number of layers desired. For example, the multilayer film may be formed from a base layer and one or more skin layers, wherein the base layer is formed from a semi-crystalline propylene-based polymer in accordance with the present invention. In such embodiments, the skin layer(s) may be formed from any film-forming polymer. If desired, the skin layer(s) may contain a softer, lower melting polymer or polymer blend that renders the layer(s) more suitable as heat seal bonding layers for thermally bonding the film to a nonwoven web. For example, the skin layer(s) may be formed from an olefin polymer or blends thereof, such as described above. Additional film-forming polymers that may be suitable for use with the present invention, alone or in combination with other polymers, include ethylene vinyl acetate, ethylene ethyl acrylate, ethylene acrylic acid, ethylene methyl acrylate, ethylene normal butyl acrylate, nylon, ethylene vinyl alcohol, polystyrene, polyurethane, and so forth.

The skin layer(s) may also contain an elastomeric polymer(s) that need not be resistant to oils or other skin care compositions. In such embodiments, the base layer may be formed with a semi-crystalline propylene-based polymer that is oil resistant to maintain the integrity of the composite even if the skin layers are adversely affected. When employed, the elastomeric polymer(s) of the skin layer(s) may include any thermoplastic elastomeric polymers, such as elastomeric polyesters, elastomeric polyurethanes, elastomeric polyamides, elastomeric block copolymers, elastomeric polyolefins, and so forth. The thickness of the skin layer(s) is generally selected so as not to substantially impair the elastomeric properties of the film. To this end, each skin layer may separately comprise from about 0.5% to about 15% of the total thickness of the film, and in some embodiments from about 1% to about 10% of the total thickness of the film. For instance, each skin layer may have a thickness of from about 0.1 to about 10 micrometers, in some embodiments from about 0.5 to about 5 micrometers, and in some embodiments, from about 1 to about 2.5 micrometers. Likewise, the base layer may have a thickness of from about 1 to about 40 micrometers, in some embodiments from about 2 to about 25 micrometers, and in some embodiments, from about 5 to about 20 micrometers.

The properties of the resulting film may generally vary as desired. For instance, prior to any stretching, the film typically has a basis weight of about 100 grams per square meter or less, and in some embodiments, from about 50 to about 75 grams per square meter. When stretched, the film may have a basis weight of about 60 grams per square meter or less, and in some embodiments, from about 15 to about 35 grams per square meter. The stretched film may also have a total thickness of from about 1 to about 100 micrometers, in some embodiments, from about 10 to about 80 micrometers, and in some embodiments, from about 20 to about 60 micrometers.

### II. Nonwoven Web Material

A nonwoven web material is generally employed in the present invention to reduce the coefficient of friction and enhance the cloth-like feel of the composite surface. Exemplary polymers for use in forming nonwoven web materials may include, for instance, polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; copolymers thereof; and so forth. If desired, biodegradable polymers, such as those described above, may also be employed. Synthetic or natural cellulosic polymers may also be used, including but not limited to, cellulosic esters; cellulosic ethers; cellulosic nitrates; cellulosic acetates; cellulosic acetate butyrates; ethyl cellulose; regenerated celluloses, such as viscose, rayon, and so forth. It should be noted that the polymer(s) may also contain other additives, such as processing aids or treatment compositions to impart desired properties to the fibers, residual amounts of solvents, pigments or colorants, and so forth.

Monocomponent and/or multicomponent fibers may be used to form the nonwoven web material. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. Nos. 4,789,592 to Taniguchi et al. and U.S. Pat. Nos. 5,336,552 to Strack et al., 5,108,820 to Kaneko, et al., 4,795,668 to Kruege, et al., 5,382,400 to Pike, et al., 5,336,552 to Strack, et al., and 6,200,669 to Marmon, et al., which are incorporated herein in their entirety by reference thereto for all purposes. Multicomponent fibers having various irregular shapes may also be formed, such as described in U.S. Pat. Nos. 5,277,976 to Hogle, et al., 5,162,074 to Hills, 5,466,410 to Hills, 5,069,970 to Largman, et al., and 5,057,368 to Largman, et al., which are incorporated herein in their entirety by reference thereto for all purposes.

Although any combination of polymers may be used, the polymers of the multicomponent fibers are typically made from thermoplastic materials with different glass transition or melting temperatures where a first component (e.g., sheath) melts at a temperature lower than a second component (e.g., core). Softening or melting of the first polymer component of the multicomponent fiber allows the multicomponent fibers to form a tacky skeletal structure, which upon cooling, stabilizes the fibrous structure. For example, the multicomponent fibers may have from about 20% to about 80%, and in some embodiments, from about 40% to about 60% by weight of the low melting polymer. Further, the multicomponent fibers may have from about 80% to about 20%, and in some embodiments, from about 60% to about 40%, by weight of the high melting polymer. Some examples of known sheath-core bicomponent fibers available from KoSa Inc. of Charlotte, N.C. under the designations T-255 and T-256, both of which use a polyolefin sheath, or T-254, which has a low melt co-polyester sheath. Still other known bicomponent fibers that may be used include those available from the Chisso Corporation of Moriyama, Japan or Fibervisions LLC of Wilmington, Del.

Fibers of any desired length may be employed, such as staple fibers, continuous fibers, etc. In one particular embodiment, for example, staple fibers may be used that have a fiber length in the range of from about 1 to about 150 millimeters, in some embodiments from about 5 to about 50 millimeters, in some embodiments from about 10 to about 40 millimeters, and in some embodiments, from about 10 to about 25 millimeters. Although not required, carding techniques may be employed to form fibrous layers with staple fibers as is well known in the art. For example, fibers may be formed into a carded web by placing bales of the fibers into a picker that separates the fibers. Next, the fibers are sent through a combing or carding unit that further breaks apart and aligns the fibers in the machine direction so as to form a machine direction-oriented fibrous nonwoven web. The carded web may then be bonded using known techniques to form a bonded carded nonwoven web.

If desired, the nonwoven web material used to form the nonwoven composite may have a multi-layer structure. Suitable multi-layered materials may include, for instance, spunbond/meltblown/spunbond (SMS) laminates and spunbond/meltblown (SM) laminates. Various examples of suitable SMS laminates are described in U.S. Pat. Nos. 4,041,203 to Brock et al.; 5,213,881 to Timmons, et al.; 5,464,688 to Timmons, et al.; 4,374,888 to Bornslaeger; 5,169,706 to Collier, et al.; and 4,766,029 to Brock et al., which are incorporated herein in their entirety by reference thereto for all purposes. In addition, commercially available SMS laminates may be obtained from Kimberly-Clark Corporation under the designations Spunguard® and Evolution®.

Another example of a multi-layered structure is a spunbond web produced on a multiple spin bank machine in which a spin bank deposits fibers over a layer of fibers deposited from a previous spin bank. Such an individual spunbond nonwoven web may also be thought of as a multi-layered structure. In this situation, the various layers of deposited fibers in the nonwoven web may be the same, or they may be different in basis weight and/or in terms of the composition, type, size, level of crimp, and/or shape of the fibers produced. As another example, a single nonwoven web may be provided as two or more individually produced layers of a spunbond web, a carded web, etc., which have been bonded together to form the nonwoven web. These individually produced layers may differ in terms of production method, basis weight, composition, and fibers as discussed above.

A nonwoven web material may also contain an additional fibrous component such that it is considered a composite. For example, a nonwoven web may be entangled with another fibrous component using any of a variety of entanglement techniques known in the art (e.g., hydraulic, air, mechanical, etc.). In one embodiment, the nonwoven web is integrally entangled with cellulosic fibers using hydraulic entanglement. A typical hydraulic entangling process utilizes high pressure jet streams of water to entangle fibers to form a highly entangled consolidated fibrous structure, e.g., a nonwoven web. Hydraulically entangled nonwoven webs of staple length and continuous fibers are disclosed, for example, in U.S. Pat. Nos. 3,494,821 to Evans and 4,144,370 to Boulton, which are incorporated herein in their entirety by reference thereto for all purposes. Hydraulically entangled composite nonwoven webs of a continuous fiber nonwoven web and a pulp layer are disclosed, for example, in U.S. Pat. Nos. 5,284,703 to Everhart, et al. and 6,315,864 to Anderson, et al., which are incorporated herein in their entirety by reference thereto for all purposes. The fibrous component of the composite may contain any desired amount of the resulting substrate. The fibrous component may contain greater than about 50% by weight of the composite, and in some embodiments, from about 60% to about 90% by weight of the composite. Likewise, the nonwoven web may contain less than about 50% by weight of the composite, and in some embodiments, from about 10% to about 40% by weight of the composite.

Although not required, the nonwoven web material may necked in one or more directions prior to lamination to the film of the present invention. Suitable techniques necking techniques are described in U.S. Pat. Nos. 5,336,545, 5,226,992, 4,981,747 and 4,965,122 to Morman, as well as U.S. Patent Application Publication No. 2004/0121687 to Morman, et al. Alternatively, the nonwoven web may remain relatively inextensible in at least one direction prior to lamination to the film. In such embodiments, the nonwoven web may be optionally stretched in one or more directions subsequent to lamination to the film.

The basis weight of the nonwoven web material may generally vary, such as from about 5 grams per square meter (“gsm”) to 120 gsm, in some embodiments from about 10 gsm to about 70 gsm, and in some embodiments, from about 15 gsm to about 35 gsm. When multiple nonwoven web materials, such materials may have the same or different basis weights.

### III. Lamination Technique

Thermal bonding techniques are generally employed in the present invention to laminate the elastic film to the nonwoven web material(s). Among other things, this minimizes the need for adhesives that either weaken in the presence of oils or that are oil-resistant, yet costly. A variety of thermal bonding techniques may be employed in the present invention. Thermal point bonding, for instance, typically employs a nip formed between two rolls, at least one of which is patterned. Ultrasonic bonding, on the other hand, typically employs a nip formed between a sonic horn and a patterned roll.

Regardless of the specific technique, thermal bonding generally involves the use of a patterned roll that contains a plurality of raised bonding elements. The pattern of the bonding elements is generally selected so that the composite has a total bond area of less than about 50% (as determined by conventional optical microscopic methods), and in some embodiments, less than about 30%. The bond density is also typically greater than about 50 bonds per square inch, and in some embodiments, from about 75 to about 500 pin bonds per square inch. One suitable bonding pattern for use in the present invention is known as an “S-weave” pattern and is described in U.S. Pat. No. 5,964,742 to McCormack, et al., which is incorporated herein in its entirety by reference thereto for all purposes. S-weave patterns typically have a bonding element density of from about 50 to about 500 bonding elements per square inch, and in some embodiments, from about 75 to about 150 bonding elements per square inch. Another suitable bonding pattern is known as the “rib-knit” pattern and is described in U.S. Pat. No. 5,620,779 to Levy, et al., which is incorporated herein in its entirety by reference thereto for all purposes. Rib-knit patterns typically have a bonding element density of from about 150 to about 400 bonding elements per square inch, and in some embodiments, from about 200 to about 300 bonding elements per square inch. Yet another suitable pattern is the “wire weave” pattern, which has a bonding element density of from about 200 to about 500 bonding elements per square inch, and in some embodiments, from about 250 to about 350 bonding elements per square inch. Other bond patterns that may be used in the present invention are described in U.S. Pat. Nos. 3,855,046 to Hansen et al.; 5,962,112 to Haynes et al.; 6,093,665 to Sayovitz et al.; D375,844 to Edwards, et al.; D428,267 to Romano et al.; and D390,708 to Brown, which are incorporated herein in their entirety by reference thereto for all purposes.

While thermal bonding allows the use of adhesives to be minimized, as noted above, the lamination conditions are generally controlled to inhibit the formation of apertures in the elastic film. The bonding temperature (e.g., the temperature of a heated roll), for instance, is typically high enough to melt and/or soften the elastomeric polymer(s) of the film at regions adjacent to the bonding elements, but not so high that substantial portions of the elastic film tear and form holes during lamination. For example, one or more rolls may be heated to a surface temperature of from about 40° C. to about 120° C., in some embodiments from about 55° C. to about 110° C., and in some embodiments, from about 60° C. to about 90° C. Once softened, the elastomeric polymer(s) may then flow and fuse to the nonwoven web material(s), thereby forming an integral nonwoven composite. The pressure exerted by rolls (“nip pressure”) during thermal bonding may be high enough to fuse the polymers, but not so high as to tear the film. For example, the nip pressure may range from about 5 to about 100 pounds per linear inch, in some embodiments from about 10 to about 75 pounds per linear inch, and in some embodiments, from about 15 to about 50 pounds per linear inch. Of course, the residence time of the materials may influence the particular bonding parameters employed.

Although not required, the elastic film and nonwoven web material(s) may sometimes be “pre-bonded” prior to thermal bonding of the materials. For example, the materials may be passed through a nip formed between two rolls, both of which are typically not patterned i.e., smooth. In this manner, a small amount of pressure is exerted on the materials to lightly bond them together prior to thermal lamination. Without intending to be limited by theory, the present inventors believe that such lightly bonded materials are less likely to form apertures during patterned bonding than completely unbonded materials. For example, the nip pressure may range from about 0.1 to about 20 pounds per linear inch, in some embodiments from about 1 to about 15 pounds per linear inch, and in some embodiments, from about 2 to about 10 pounds per linear inch. Although a bonding temperature may be selected that softens the elastomeric polymer, it is normally desired that the polymer adheres to the nonwoven web materials(s) primarily based on its tackiness. For example, one or more of the rolls may have a surface temperature of from about 15° C. to about 60° C., in some embodiments from about 20° C. to about 50° C., and in some embodiments, from about 25° C. to about 40° C.

Another parameter that may be controlled to inhibit the formation of apertures is the degree of tension on the film during lamination. When the tension of the film is increased to a certain extent, apertures are more likely to form in the film as it is subjected to heat and/or pressure. While avoiding aperture formation, the film may nevertheless be stretched by rolls rotating at different speeds of rotation so that the sheet is stretched to the desired stretch ratio in the machine direction. For example, a stretch ratio of about 4.0 or less, in some embodiments about 3.5 or less, and in some embodiments, from about 1.0 to about 2.5, is employed to achieve the desired degree of tension in the film during lamination. The stretch ratio may be determined by dividing the final length of the film by its original length. The stretch ratio may also be approximately the same as the draw ratio, which may be determined by dividing the linear speed of the film during lamination (e.g., speed of the nip rolls) by the linear speed at which the film is formed (e.g., speed of casting rolls or blown nip rolls).

The manner in which the film is stretched is not critical. Thus, for example, the film may be stretched during lamination to a certain extent as described above. In addition, the film may also be “pre-stretched” (prior to lamination), such as during the above-described pre-bonding of the elastic film to the nonwoven web material(s). The orientation temperature profile during the “pre-stretching” operation is generally below the melting point of one or more polymers in the film, but high enough to enable the composition to be drawn or stretched. For example, the film may be stretched at a temperature from about 10° C. to about 50° C., in some embodiments from about 15° C. to about 40° C., and in some embodiments, from about 20° C. to about 40° C. When “pre-stretched”, the degree of stretch during lamination may be increased, maintained, or reduced (retracted) to the desired degree of tension.

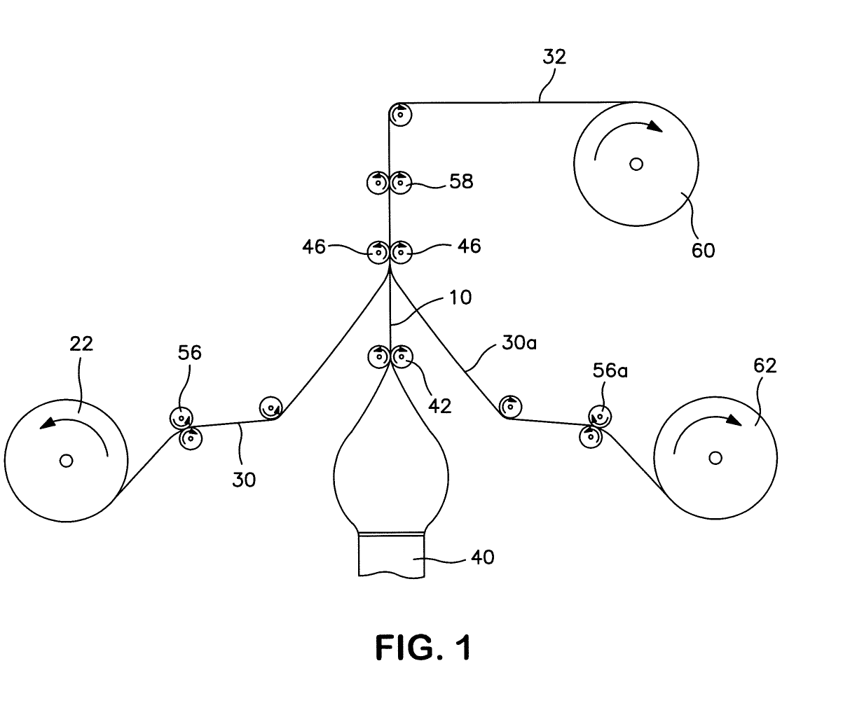

Various embodiments of the present invention will now be described in greater detail. Of course, it should be understood that the description provided below is merely exemplary, and that other methods are contemplated by the present invention. Referring to FIG. 1, for instance, one embodiment of a method for forming a composite from an elastic film and a nonwoven web material is shown. As shown, the raw materials of the film (e.g., elastomeric polymer) may be dry mixed together (i.e., without a solvent) and added to a hopper (not shown) of an extrusion apparatus 40. The raw materials may alternatively be blended with a solvent. In the hopper, the materials are dispersively mixed in the melt and compounded using any known technique, such as batch and/or continuous compounding techniques that employ, for example, a Banbury mixer, Farrel continuous mixer, single screw extruder, twin screw extruder, etc.

Any known technique may be used to form a film from the compounded material, including blowing, casting, flat die extruding, etc. In one particular embodiment, the film may be formed by a blown process in which a gas (e.g., air) is used to expand a bubble of the extruded polymer blend through an annular die. The bubble is then collapsed and collected in flat film form. Processes for producing blown films are described, for instance, in U.S. Pat. Nos. 3,354,506 to Raley; 3,650,649 to Schippers; and 3,801,429 to Schrenk et al., as well as U.S. Patent Application Publication Nos. 2005/0245162 to McCormack, et al. and 2003/0068951 to Boggs, et al., all of which are incorporated herein in their entirety by reference thereto for all purposes. For example, in the particular embodiment of FIG. 1, the compounded material (not shown) is supplied to the extrusion apparatus 40 and then blown into nip rolls 42 to form a single-layered precursor elastic film 10. The rolls 42 may be kept at temperature sufficient to solidify and quench the precursor elastic film 10 as it is formed, such as from about 20 to 60° C. Typically, the resulting precursor elastic film is generally unapertured, although it may of course possess small cuts as a result of processing.

A nonwoven web is also employed for laminating to the elastic film 10. For example, a nonwoven web 30 may simply be unwound from a supply roll 22 as shown in FIG. 1. Alternatively, the nonwoven web may be formed in-line, such as by dispensing polymer filaments from a pair of spinnerettes onto a conveyor assembly. In FIG. 1, the web 30 is compressed to form inter-filament bonding using a pair of nip rollers 56. Following compaction, the nonwoven web 30 is directed to a nip defined between rolls 58 for laminating to the elastic film 10. Various techniques may be utilized to bond the elastic film 10 to the nonwoven web 30. Although not necessarily required, a second material 30a originating from a supply roll 62 and passing through nip rollers 56a may also be laminated to the elastic film 10. The second material 30a may be a second nonwoven web material, film, etc.

Referring again to FIG. 1, the elastic film 10 and nonwoven web materials 30 and 30a are directed to a nip defined between a set of pre-bonding rolls 46. Both of the rolls 46 possess a smooth surface that lightly bonds the elastic film 10 and nonwoven materials 30 and 30a. In this particular embodiment, the rolls 46 traveling at a speed that is greater than the nip rolls 42 so that the elastic film 10 is also stretched and thinned in the machine direction. While two rolls 46 are illustrated in FIG. 1, it should be understood that the number of rolls may be higher or lower, depending on the level of stretch that is desired and the degrees of stretching between each roll. The film may be stretched in either single or multiple discrete stretching operations. Alternatively, the elastic film may also be stretched using a conventional film-orientation unit or machine direction orienter (“MDO”), such as commercially available from Marshall and Williams, Co. of Providence, R.I.

In any event, thermal bonding techniques are employed to laminate the material(s) to the elastic film. In FIG. 1, for instance, the materials 30 and 30a are directed to a nip defined between rolls 58 for laminating to the elastic film 10. One or both of the rolls 58 may contain a plurality of raised bonding elements and/or may be heated. Preferably, rolls 58 are rotating at a speed that is slower than rolls 57 or at least at a speed that allows the prebonded laminate 57a to retract due to the tensioning of elastic film 10. Upon lamination, the elastic film 10 is thermally fused to the nonwoven web materials 30 and 30a at a plurality of discrete bond sites. That is, the elastomeric polymer(s) of the film 10 are softened and/or melted so that they may physically entrap fibers of the nonwoven web materials 30 and 30a. Of course, the elastic film 10 may possess a certain tackiness so as to further adhere to the fibers upon lamination.

The resulting composite 32 may then be wound and stored on a take-up roll 60. Optionally, the composite 32 is kept under tension, such as by using the same linear velocity for the roll 60 as the speed of one or more of the stretching rolls 46. More preferably, however, the composite 32 is allowed to slightly retract prior to winding on to the take-up roll 60. This may be achieved by using a slower linear velocity for the roll 60. When the elastic film 10 is tensioned prior to lamination, it will retract toward its original machine direction length and become shorter in the machine direction, thereby buckling or forming gathers in the composite. The resulting elastic composite thus becomes extensible in the machine direction to the extent that the gathers or buckles in the web may be pulled back out flat and allow the elastic film 10 to elongate.

While not shown in FIG. 1, various additional potential processing and/or finishing steps known in the art, such as slitting, treating, printing graphics, etc., may be performed without departing from the spirit and scope of the invention. For instance, the composite may optionally be mechanically stretched in the cross-machine and/or machine directions to enhance extensibility. In one embodiment, the composite may be coursed through two or more rolls that have grooves in the CD and/or MD directions. Such grooved satellite/anvil roll arrangements are described in U.S. Patent Application Publication Nos. 2004/0110442 to Rhim, et al. and 2006/0151914 to Gerndt, et al., which are incorporated herein in their entirety by reference thereto for all purposes. For instance, the laminate may be coursed through two or more rolls that have grooves in the CD and/or MD directions. The grooved rolls may be constructed of steel or other hard material (such as a hard rubber). If desired, heat may be applied to the composite just prior to or during the application of incremental stretch to cause it to relax somewhat and ease extension. Heat may be applied by any suitable method known in the art, such as heated air, infrared heaters, heated nipped rolls, or partial wrapping of the laminate around one or more heated rolls or steam canisters, etc. Heat may also be applied to the grooved rolls themselves. It should also be understood that other grooved roll arrangement are equally suitable, such as two grooved rolls positioned immediately adjacent to one another.

Besides grooved rolls, other techniques may also be used to mechanically stretch the composite in one or more directions. For example, the composite may be passed through a tenter frame that stretches the composite. Such tenter frames are well known in the art and described, for instance, in U.S. Patent Application Publication No. 2004/0121687 to Morman, et al. The composite may also be necked. Suitable techniques necking techniques are described in U.S. Pat. Nos. 5,336,545, 5,226,992, 4,981,747 and 4,965,122 to Morman, as well as U.S. Patent Application Publication No. 2004/0121687 to Morman, et al., all of which are incorporated herein in their entirety by reference thereto for all purposes.

As a result of the present invention, an elastic composite may be formed that has a variety of beneficial properties. As noted above, for example, the elastic film is generally resistant to oils (e.g., mineral oil) and is thus able to maintain good stretch and recovery properties during use. Moreover, although the individual nonwoven web materials(s) may be pervious to liquids, the composite as a whole is generally considered liquid-impervious. Consequently, the composite may act as a barrier to oils or other liquids, whether oil-based, aqueous-based, etc., and thus minimize leakage of a composition applied thereto. The liquid-impervious nature of the elastic composite is based primarily on the lack of apertures in the elastic film. Namely, the elastic film typically lacks apertures of a sufficient size to allow liquids to flow therethrough. For example, the film may be generally free of apertures having a size (largest dimension) of about 100 micrometers or greater, in some embodiments about 50 micrometers or greater, and in some embodiments, about 10 micrometers or greater. A “liquid-impervious” material may be any material that passes the mineral oil strikethrough test, which is performed in substantial accordance with ASTM F 1670-03 (with the exception that synthetic blood is substituted with mineral oil) as described below. In addition to its liquid-impermeability, the elastic composite of the present invention is also relatively impervious to vapors. That is, the composite may have a “Frazier permeability” of about 1 ft³/min or less, in some embodiments about 0.5 ft³/min or less, and in some embodiments, 0.1 ft³/min or less. Frazier permeability is measured at ambient conditions as standard cubic feet per minute of air flow across a material, per square foot of material with an air pressure differential of 0.5 inches of water (125 Pa) across the sample.

Due to its unique combination of mechanical, elastomeric, and barrier properties, the elastic composite of the present invention may be used in a wide variety of products. For example, the elastic composite may be used to form a skin care product that defines an interior into which a user may insert a portion of his or her body (e.g., a finger, toe, hand, foot, wrist, forearm, etc.). Alternatively, the product may simply be placed on or wrapped around the skin. The skin care product may transfer a skin care composition to the skin and/or impede or reduce the amount of liquid, such as water, that can migrate from the skin to optimize hydration or moisturization. Regardless, the elastic composite may form the entire skin care product, or simply a portion of the product. For example, the product may include a elastic composite that is joined to one or more substrates, such as a woven fabric, nonwoven fabric, knit fabric, film, foam, elastic material, etc. If desired, multiple elastic composites may be joined to one another and employed in the present invention.

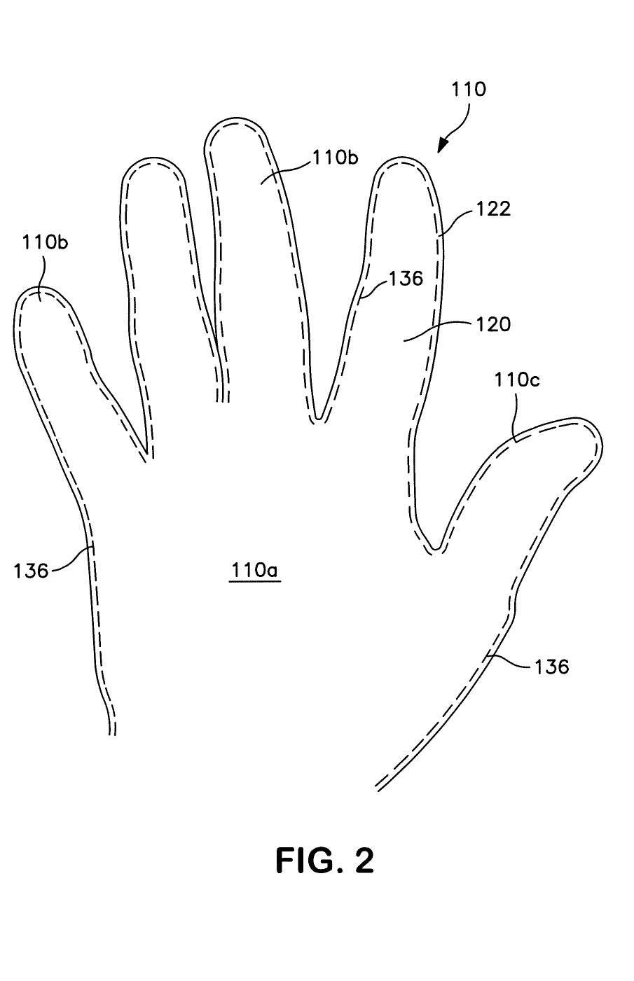

The shape and size of the elastic composite may be tailored to the particular skin care product. For example, the elastic composite may be provided in the shape of a glove, tube, sleeve, mitten, sock, circle, rectangular, square, etc. Referring to FIG. 2, for instance, one embodiment of a glove 110 is shown that is in the shape of a human hand. The glove 110 has a palm region 110a, a plurality of finger portions 110b, and a thumb portion 110c. In this particular embodiment, the glove 110 contains first and second elastic composites 120 and 122, respectively, formed in accordance with the present invention. The composites 120 and 122 are joined at a location proximate to their perimeters by sewing and then inverting the glove 110 so that a seam 136 becomes located on the interior of the glove 110. Of course, the glove 110 need not be inverted, and the seam 136 can remain on the exterior of the glove 110. Also, the composites 120 and 122 need not be joined in a way that produces a seam. For example, the edges of the individual substrates 120 and 122 may be placed adjacent to each other and joined ultrasonically, thermally, adhesively, cohesively, using tape, by fusing the materials together (e.g., by using an appropriate solvent), by welding the materials together, or by other approaches. The glove 110 may be used in the application of a skin care composition, such as for moisturizing and/or hydrating the skin. For example, the glove 110 may be pre-treated or donned over a hand treated with the skin care composition. Because the glove 110 is constructed from the elastic composite of the present invention, the glove 110 will also resist attack from oil-based formulations and, therefore, retain its elasticity.

A variety of skin care compositions may be used in conjunction with the personal care product. By way of example only, such compositions may include emulsifiers, surfactants, peptides, viscosity modifiers, natural moisturizing factors, antimicrobial actives, pH modifiers, enzyme inhibitors/inactivators, suspending agents, pigments, dyes, colorants, buffers, perfumes, antibacterial actives, antifungal actives, pharmaceutical actives, film formers, deodorants, opacifiers, astringents, solvents, organic acids, preservatives, drugs, vitamins, aloe vera, and the like. The composition may include specific additives such as emollients, which help restore dry skin to a more normal moisture balance. Emollients act on the skin by supplying fats and oils that blend in with skin, making it pliable, repairing some of the cracks and fissures in the stratum corneum, and forming a protective film that traps water in the skin. Suitable emollients may include beeswax, butyl stearate, cermides, cetyl palmitate, eucerit, isohexadecane, isopropyl palmitate, isopropyl myristate, mink oil, mineral oil, nut oil, oleyl alcohol, petroleum jelly or petrolatum, glyceral stearate, avocado oil, jojoba oil, lanolin (or woolwax), lanolin derivatives such as lanolin alcohol, retinyl palmitate (vitamin A derivative), cetearyl alcohol, squalane, squalene, stearic acid, stearyl alcohol, myristal myristate, certain hydrogel emollients, various lipids, decyl oleate and castor oil.

Other agents that may be suitable for use in the composition include antioxidants. Antioxidants prevent or slow the oxidation process, thereby protecting the skin from premature aging. Exemplary antioxidants for use in the present invention include ascorbic acid ester, vitamin C (ascorbic acid), vitamin E (lecithin), α-glycosyl rutin (AGR, or Alpha Flavon, a plant-derived antioxidant), and coenzyme Q10 (also known as ubiquinone). Still other beneficial agents which may be delivered to the skin during use of an embodiment of the present invention include chelating agents, such as EDTA; absorptive/neutralizing agents, such as kaolin, hectorite, smectite, or bentonite; other vitamins and vitamin sources and derivatives, such as panthenol, retinyl palmitate, tocopherol, and tocopherol acetate; and anti-irritants such as chitin and chitosan.

Additional examples of beneficial agents that may be present in compositions that may be used with the present invention include skin conditioners, which help the skin retain moisture, improve softness, or improve texture. Skin conditioners include, for example, amino acids, including alanine, serine, and glycine; allantoin, keratin, and methyl glucose dioleate; α-hydroxy acids, including lactic acid and glycolic acid, which act by loosening dead skin cells from the skin's surface; moisturizers (agents that add or hold water in dry skin), including echinacea (an extract of the coneflower plant), shea butter, and certain silicones, including cyclomethicon, dimethicone, and simethicone. Other examples of beneficial botanical agents, extracts, or other materials that may be suitable for use with the present invention include almonds, chamomile extracts such as bisabolol (believed to relieve irritation, swelling and itching in the skin), elder flowers, honey, safflower oil, and elastin (safflower oil and elastin are believed to aid in retaining skin elasticity).

In addition to one or more agents as described above that may have clinically beneficial effect on the wearer's skin, other additives may be included in the composition. For example, a silicone polymer may be included to improve the slip characteristics of the elastomeric substrate. Possible silicone polymers include reactive silicones, non-reactive silicones, or a mixture of reactive and non-reactive silicones. Suitable silicones may include, for example, aminosilicones, polyether-modified amino silicones, amino-substituted siloxanes having terminal hydroxy groups, epoxy silicones, quaternary silicones, dimethicone, silicone polyethers, polyether epoxy silicones, silanol fluids, polysiloxy linoleyl pyrrolidone phospholipids, and combinations of possible silicones.

The composition may be applied to the appliance as an aqueous solution, a dispersion, or an emulsion. For example, in one embodiment, the personal-care composition may be applied to the surface of the substrate as a micro-emulsion. A micro-emulsion is a particularly fine-particle emulsion that can be applied in a spray form. The particle size of a micro-emulsion is generally less than about one micron, whereas traditional emulsions demonstrate particle sizes of greater than about 50 microns.

In addition to skin care products, the elastic composite of the present invention may also be employed in other applications. For example, the elastic composite may be used in safety gloves, healthcare or emergency warming gloves or socks, cosmetic gloves or socks, pregnancy supports, leg supports, and a wide variety of other health or hygiene related products. The elastic composite may also be used in an absorbent article that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, and so forth; medical absorbent articles, such as garments, fenestration materials, underpads, bedpads, bandages, absorbent drapes, and medical wipes; food service wipers; clothing articles; and so forth. Typically, absorbent articles include a substantially liquid-impermeable layer (e.g., outer cover), a liquid-permeable layer (e.g., bodyside liner, surge layer, etc.), and an absorbent core. In one particular embodiment, the elastic composite of the present invention may be used in providing elastic waist, leg cuff/gasketing, stretchable ear, side panel, etc.

The present invention may be better understood with reference to the following examples.

### Test Methods

Cycle Testing

The materials were tested using a cyclical testing procedure to determine load loss and percent set. In particular, 2-cycle testing was utilized to 100% defined elongation. For this test, the sample size was 3 inches in the cross-machine direction by 6 inches in the machine direction. The Grip size was 3 inches in width. The grip separation was 4 inches. The samples were loaded such that the machine direction of the sample was in the vertical direction. A preload of approximately 10 to 15 grams was set. The test pulled the sample to 100% elongation at a speed of 20 inches per minute, and then immediately (without pause) returned to the zero at a speed of 20 inches per minute. The results of the test data are all from the first and cycles. The testing was done on a Sintech Corp. constant rate of extension tester 2/S with a Renew MTS mongoose box (control) using TESTWORKS 4.07b software (Sintech Corp, of Cary, N.C.). The tests were conducted under ambient conditions.

Mineral Oil Strikethrough Test:

With the exception that mineral oil was used instead of synthetic blood, the barrier properties of the samples for mineral oil were measured in accordance with ASTM F 1670-03, which is incorporated herein in its entirety by reference thereto for all purposes. The mineral oil used in this test was Penreco® Peneteck® Light Mineral Oil, NF, which is available from Penreco of Los Angeles, Calif. In the test, the mineral oil was poured into a chamber and allowed to contact the sample for 5 minutes at ambient pressure. Then, a pressure differential of 2 pounds per square inch is applied for 1 minute. The pressure is returned to ambient conditions and the sample is allowed to remain in contact with the oil for an additional 54 minutes. Visual observation alone was used to determine when, or if, penetration occurs. Results are reported as pass (“compliant”) or fail. A sample that passes the strikethrough test is considered to have met the standard of ASTM F 1670-03.

### EXAMPLE 1

The ability to form an elastic nonwoven composite was demonstrated. The elastic film was formed from 100 wt. % of VISTAMAXX™ 1100 (ExxonMobil Chemical Co.). VISTAMAXX™ 1100 is a metallocene-catalyzed propylene-ethylene plastomer having a density of 0.860 grams per cubic centimeter and a melt flow rate of 3 grams per 10 minutes (230° C., 2.16 kg). A “Killion” blown film line (available from Davis-Standard of Pawcatuck, Conn., 3.8-centimeter diameter annular film die) was used to form a blown film. Specifically, the elastic polymer was heated to about 380° F. (193° C.) and extruded through the annular die at a rate of 30 RPMs and an exit pressure of 3050 pounds per square inch. The extruded elastic film composition was blown to a blow up ratio of about 3.5 by supplying air at ambient temperatures. The film bubble was then collapsed in a collapsing nip to form a precursor film sheet having a width of about 9 inches (about 22.9 centimeters) and a basis weight of approximately 49 grams per square meter.

Upon formation, the blown film was thermally bonded between two polypropylene spunbond facings having a basis weight of approximately about 14 grams per square meter and bonded with a wire-weave pattern. The spunbond facings were unwound from respective supply rolls at a rate of about 80 feet per minute (about 24.4 meters per minute) and fed into a secondary nip so that one nonwoven web is pressed against each side surface of the precursor film sheet to form a lightly bonded tri-laminate material (“prebond” configuration). The rollers of the secondary nip were not heated. Thereafter, the layers were relaxed and fed between an anvil and patterned roll (S-weave). The patterned roll was heated to a roll surface temperature of 185° F. (85° C.), the anvil roll was heated to a roll surface temperature of 180° F. (82.2° C.), and the pressure was 25 pounds per linear inch. The rolls operated at a speed of 50 feet per minute. The resulting elastic composite was then wound onto a roll in a relaxed state at 34 feet per minute. The final basis weight was approximately 123 grams per square meter.

### EXAMPLE 2

An elastic nonwoven composite was formed as described in Example 1, except that the anvil/patterned rolls operated at a pressure of about 29 pounds per linear inch and the winder speed was about 37 feet per minute.

### EXAMPLE 3

An elastic nonwoven composite was formed as described in Example 2, except that the anvil/patterned rolls operated at a pressure of about 38 pounds per linear inch.

### EXAMPLE 4

An elastic nonwoven composite was formed as described in Example 2, except that the anvil/patterned rolls operated at a speed of about 80 feet per minute.

### EXAMPLE 5

An elastic nonwoven composite was formed as described in Example 4, except that the anvil/patterned rolls operated at a pressure of about 25 pounds per linear inch. The basis weight of the film was 53 grams per square meter, and the basis weigh to the composite was 117 grams per square meter.

### EXAMPLE 6

An elastic nonwoven composite was formed as described in Example 4, except that no anvil/patterned rolls were employed. The basis weight of the film was 46 grams per square meter, and the basis weigh to the composite was 108 grams per square meter.

### EXAMPLE 7

An elastic nonwoven composite was formed as described in Example 5, except that the secondary rollers were not employed. The basis weight of the film was 100 grams per square meter, and the basis weigh to the composite was 172 grams per square meter.

### EXAMPLE 8

An elastic nonwoven composite was formed as described in Example 4, except that no anvil/patterned rolls were employed.

### EXAMPLE 9

An elastic nonwoven composite was formed as described in Example 8, except that the polymer was extruded through the annular die at a rate of 15 RPMs.

### EXAMPLE 10

The ability to form an elastic nonwoven composite was demonstrated. The elastic film was formed from 100 wt. % of KRATON® MD6673 (Kraton Polymers, LLC of Houston Tex.). KRATON® MD6673 contains 68 wt. % of a styrene-ethylene-butylene-styrene block copolymer (KRATON® MD6673), 20 wt. % REGALREZ™ 1126 (Eastman Chemical) and 12 wt. % EPOLENE™ C-10 polyethylene wax (Eastman Chemical). A “Killion” blown film line (available from Davis-Standard of Pawcatuck, Conn., 3.8-centimeter diameter annular film die) was used to form a blown film. Specifically, the elastic polymer was heated to about 380° F. (193° C.) and extruded through the annular die at a rate of 30 RPMs and an exit pressure of 2250 pounds per square inch. The extruded elastic film composition was blown to a blow up ratio of about 3.5 by supplying air at ambient temperatures. The film bubble was then collapsed in a collapsing nip to form a precursor film sheet having a width of about 9 inches (about 22.9 centimeters) and a basis weight of approximately 75 grams per square meter.

Upon formation, the blown film was thermally bonded between two polypropylene spunbond facings having a basis weight of approximately about 14 grams per square meter and bonded with a wire-weave pattern. The spunbond facings were unwound from respective supply rolls at a rate of about 80 feet per minute (about 24.4 meters per minute) and fed into a secondary nip so that one nonwoven web is pressed against each side surface of the precursor film sheet to form a lightly bonded tri-laminate material (“prebond” configuration). The rollers of the secondary nip were not heated. Thereafter, the layers were relaxed and fed between an anvil and patterned roll (S-weave). The patterned roll was heated to a roll surface temperature of 185° F. (85° C.), the anvil roll was heated to a roll surface temperature of 180° F. (82.2° C.), and the pressure was 25 pounds per linear inch. The rolls operated at a speed of 50 feet per minute. The resulting elastic composite was then wound onto a roll in a relaxed state at 34 feet per minute. The final basis weight was approximately 169 grams per square meter.

### EXAMPLE 11

An elastic nonwoven composite was formed as described in Example 10, except that the anvil/patterned rolls operated at a pressure of about 38 pounds per linear inch and the winder speed was about 37 feet per minute.

### EXAMPLE 12

An elastic nonwoven composite was formed as described in Example 11, except that the anvil/patterned rolls operated at a speed of about 80 feet per minute.

### EXAMPLE 13

An elastic nonwoven composite was formed as described in Example 12, except that the anvil/patterned rolls operated at a pressure of about 25 pounds per linear inch. The basis weight of the film was 74 grams per square meter, and the basis weigh to the composite was 164 grams per square meter.

### EXAMPLE 14

An elastic nonwoven composite was formed as described in Example 13, except that no anvil/patterned rolls were employed. The basis weight of the film was 78 grams per square meter, and the basis weigh to the composite was 174 grams per square meter.

### EXAMPLE 15

An elastic nonwoven composite was formed as described in Example 13, except that the secondary rollers were not employed. The basis weight of the film was 119 grams per square meter, and the basis weigh to the composite was 199 grams per square meter.

### EXAMPLE 16

An elastic nonwoven composite was formed as described in Example 12, except the secondary rollers were not employed.

### EXAMPLE 17

The ability to form an elastic nonwoven composite was demonstrated. The elastic film was formed from 96 wt. % of VISTAMAXX™ 1100 (ExxonMobil Chemical Co.) and 4 wt. % SCC11692 pigment (Standridge Color Corp.). The SCC116921 pigment contained titanium dioxide blended with polypropylene and polypropylene random copolymers. The polymer composition was extruded at a melt temperature of 435° F. and cast onto a chill roll (set to a temperature of about 80° F.) operating at a speed of about 54 feet per minute. The basis weight of the film was 53 grams per square meter. Upon formation, the cast film was thermally bonded between two polypropylene spunbond facings having a basis weight of approximately about 14 grams per square meter and bonded with a wire-weave pattern. The spunbond facings were unwound from respective supply rolls at a rate of about 80 feet per minute (about 24.4 meters per minute). Thereafter, the layers were relaxed and fed between an anvil and patterned roll (S-weave). The patterned roll was heated to a roll surface temperature of 260° F., the anvil roll was heated to a roll surface temperature of 260° F., and the pressure was 35 pounds per square inch. The rolls operated at a speed of 162 feet per minute. The resulting elastic composite was then wound onto a roll in a relaxed state at 34 feet per minute. The final basis weight was approximately 139 grams per square meter.

### EXAMPLE 18

The ability of the composites of Examples 1, 5-7, 10, 13-15, and 17 to act as a barrier to oil penetration was tested in a manner as described above. Only samples 10 and 13-15 (containing Kraton® MD6673 in the elastic film) failed to pass the oil penetration test. The elasticity (e.g., cycle testing) of the samples was also tested. The results are set forth below in Tables 1 and 2.

TABLE 1
1^{st} Cycle

| | Cycle 1 | | | | | | | |
|---|---|---|---|---|---|---|---|---|
| | | | | | | | | Percent |
| | Up 50% | Up 75% | Up 100% | Down 50% | Down 75% | Down 100% | Hyst. Loss | Set |
| Example | (g_{f}) | (g_{f}) | (g_{f}) | (g_{f}) | (g_{f}) | (g_{f}) | (%) | (%) |
| 1 | 1382 | 1735 | 2046 | 557 | 888 | 1773 | 52.2 | 11.5 |
| 5 | 1428 | 1762 | 2220 | 510 | 825 | 1886 | 56.3 | 10.7 |
| 6 | 1504 | 2152 | 5119 | 527 | 891 | 3676 | 58.7 | 13.3 |
| 7 | 2281 | 2725 | 3175 | 1094 | 1597 | 2844 | 45.4 | 7.7 |
| 10 | 1372 | 1614 | 1816 | 755 | 1103 | 1691 | 39.2 | 9.2 |
| 13 | 1432 | 1704 | 1947 | 790 | 1163 | 1812 | 39 | 9.7 |
| 14 | 1267 | 1487 | 1662 | 747 | 1068 | 1563 | 36.2 | 8.5 |
| 15 | 1996 | 2462 | 2832 | 1245 | 1798 | 2669 | 32.6 | 7.3 |
| 17 | 1122 | 1423 | 6249 | 425 | 682 | 4557 | 59.1 | 13.5 |

TABLE 2
2^{nd} Cycle

| | Cycle 2 | | | | |
|---|---|---|---|---|---|
| | Up 50% | Up 100% | Down 50% | Down 100% | Hyst. Loss |
| Example | (g_{f}) | (g_{f}) | (g_{f}) | (g_{f}) | (%) |
| 1 | 817.5 | 1881 | 536 | 1706 | 28.8 |
| 5 | 788.1 | 2019 | 490 | 1802 | 31.4 |
| 6 | 770.3 | 4289 | 515 | 3611 | 29.5 |
| 7 | 1421.3 | 2938 | 1060 | 2744 | 21.8 |
| 10 | 1037.6 | 1746 | 727 | 1656 | 24.5 |
| 13 | 1091.9 | 1870 | 763 | 1773 | 24.8 |
| 14 | 997.7 | 1601 | 722 | 1531 | 22.9 |
| 15 | 1589.1 | 2733 | 1213 | 2624 | 19.4 |
| 17 | 642.8 | 5391 | 415 | 4519 | 28.8 |

As indicated above, the composites of the present invention exhibited elastic characteristics.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A nonwoven composite comprising an elastic film positioned adjacent and thermally fused to a nonwoven web material at a plurality of discrete bond sites, the elastic film comprising a semi-crystalline propylene-based polymer having a density of about 0.88 grams per cubic centimeter or less, wherein the composite is substantially liquid-impervious.

2. The nonwoven composite of claim 1, wherein the propylene-based polymer is a copolymer of propylene and an α-olefin.

3. The nonwoven composite of claim 2, wherein the α-olefin is ethylene.

4. The nonwoven composite of claim 2, wherein propylene constitutes from about 60 mole % to about 99.5 mole % of the copolymer and the α-olefin constitutes from about 0.5 mole % to about 40 mole % of the copolymer.

5. The nonwoven composite of claim 1, wherein the propylene-based polymer is single-site catalyzed.

6. The nonwoven composite of claim 1, wherein the propylene-based polymer has a density of from about 0.83 to about 0.88 grams per cubic meter.

7. The nonwoven composite of claim 1, wherein the propylene-based polymer has a density of from about 0.85 to about 0.87 grams per cubic meter.

8. The nonwoven composite of claim 1, wherein the propylene-based polymer has a melt flow rate of from about 0.1 to about 10 grams per 10 minutes.

9. The nonwoven composite of claim 1, wherein the propylene-based polymer has a melt flow rate of from about 0.5 to about 4 grams per 10 minutes.

10. The nonwoven composite of claim 1, wherein semi-crystalline propylene-based polymers constitute about 80 wt. % or more of the film.

11. The nonwoven composite of claim 1, wherein the nonwoven web material contains spunbond fibers, meltblown fibers, staple fibers, or combinations thereof.

12. The nonwoven composite of claim 1, wherein the nonwoven web material contains a polyolefin.

13. The nonwoven composite of claim 12, wherein the polyolefin is polypropylene.

14. The nonwoven composite of claim 1, wherein the elastic film is positioned between the nonwoven web material and an additional nonwoven web material.

15. The nonwoven composite of claim 1, wherein the composite is elastic in the machine direction.

16. The nonwoven composite of claim 15, wherein the composite is elastic in the cross-machine direction.

17. The nonwoven composite of claim 1, wherein the nonwoven web material is extensible in the cross-machine direction.

18. The nonwoven composite of claim 17, wherein the nonwoven material is necked.

19. A skin care product that comprises the nonwoven composite of claim 1.

20. The skin care product of claim 19, further comprising a skin care composition that is applied to the nonwoven composite.

21. The skin care product of claim 19, wherein the skin care composition is an oil, wax, cream, lotion, or gel.

22. The skin care product of claim 19, wherein the product is in the form of a glove or sock.

23. A method of forming a nonwoven composite, the method comprising:
forming an elastic film from a polymer composition, the polymer composition comprising a semi-crystalline propylene-based polymer having a density of about 0.88 grams per cubic centimeter or less;
passing the film and a nonwoven web material through a nip formed by at least one patterned roll; and
at the nip, thermally fusing the film to the nonwoven web material, the thermally fused film being generally free of apertures having a size of about 10 micrometers or greater.

24. The method of claim 23, wherein the propylene-based polymer is a copolymer of propylene and an α-olefin.

25. The method of claim 24, wherein the α-olefin is ethylene.

26. The method of claim 23, wherein the propylene-based polymer is single-site catalyzed.

27. The method of claim 23, wherein the propylene-based polymer has a density of from about 0.83 to about 0.88 grams per cubic meter.

28. The method of claim 23, wherein the propylene-based polymer has a density of from about 0.85 to about 0.87 grams per cubic meter.

29. The method of claim 23, wherein the propylene-based polymer has a melt flow rate of from about 0.1 to about 10 grams per 10 minutes.

30. The method of claim 23, wherein the propylene-based polymer has a melt flow rate of from about 0.5 to about 4 grams per 10 minutes.

31. The method of claim 23, wherein semi-crystalline propylene-based polymers constitute about 80 wt. % or more of the film.

32. The method of claim 23, wherein the nonwoven web material contains spunbond fibers, meltblown fibers, staple fibers, or combinations thereof.

33. The method of claim 23, wherein the elastic film is stretched in the machine direction.

34. The method of claim 33, wherein the elastic film is stretched prior to passing through the nip.

35. The method of claim 33, further comprising passing the elastic film through a pre-bonding nip before passing the film through the nip defined by the at least one patterned roll.

36. The method of claim 35, wherein the elastic film is stretched at the pre-bonding nip.

37. The method of claim 36, further comprising allowing the elastic film to retract in the machine direction between the pre-bonding nip and the nip defined by the at least one patterned roll.

38. The method of claim 33, wherein the elastic film is stretched at the nip defined by the at least one patterned roll.

39. The method of claim 33, wherein the elastic film is stretched in the cross-machine direction.

40. The method of claim 23, wherein the nip is formed between two rolls.

41. The method of claim 40, wherein at least one of the rolls is heated to a surface temperature of from about 40° C. to about 120° C.

42. The method of claim 40, wherein a pressure of from about 5 to about 100 pounds per linear inch is applied at the nip.

43. The method of claim 40, wherein a pressure of from about 15 to about 50 pounds per linear inch is applied at the nip.

44. The method of claim 23, wherein an additional nonwoven web material is passed through the nip so that the elastic film is positioned between the nonwoven web materials.

45. The method of claim 23, further comprising allowing the composite to retract in the machine direction prior to or during winding onto a roll.

46. The method of claim 23, wherein the composite is substantially liquid-impervious.
